(19) United States
(12) Patent Application Publication
(10) Pub. No.: US 2025/0372907 A1
(43) Pub. Date: Dec. 4, 2025

(54) ELECTRICAL CONTACT FOR USE IN AN ELECTRICAL WIRING DEVICE

(71) Applicant: LEVITON MANUFACTURING CO., INC., Melville, NY (US)

(72) Inventor: Zachary Ednie, Farmingdale, NY (US)

(73) Assignee: LEVITON MANUFACTURING CO., INC., Melville, NY (US)

(21) Appl. No.: 18/731,569

(22) Filed: Jun. 3, 2024

(51) Int. Cl. H01R 13/11; H01R 13/15

(52) U.S. Cl. CPC H01R 13/113; H01R 13/15

(57) ABSTRACT

The present disclosure relates to an improved electrical contact configured to be used in a wiring device (e.g., an electrical receptacle, a GFCI, an AFCI, etc.). The electrical contact being arranged and configured to apply a compressive force against a plug blade from a plug inserted therein. In some embodiments, the electrical contact includes a base or terminal portion and first and second arms or wipes extending from the base or terminal portion, the arms or wipes including extending members or segments. The extending members or segments arranged and configured to contact a wall or surface of the housing of the wiring device to assist in providing the compressive force.

### TECHNICAL FIELD

The present disclosure is directed to wiring devices and, more particularly, to an improved electrical contact for use in a wiring device, the electrical contact configured to provide improved blade retention and/or thermal performance.

### BACKGROUND

Generally speaking, as will be readily appreciated by one of ordinary skill in the art, to route, install and otherwise use AC electrical power, manufactures produce many different kinds of electrical devices. These electrical devices are referred to herein as wiring devices. Examples of wiring devices include electrical receptacles, ground/arc fault circuit interrupters (GFCIs, AFCIS, etc.), switches, dimmers, occupancy sensors, lighting fixtures, fan speed controls, energy management devices, surge suppressors, and the like. Other forms of wiring devices include receptacles, plug and connectors, pin and sleeves, and the like. Such wiring devices can be configured as any suitable grade, such as residential, commercial, industrial, heavy-duty, extra heavy duty, and/or hospital grade.

Generally speaking, in use, wiring devices are connected to AC electrical power via wires/conductors (the terms wire and conductor may be used hereinafter synonymously), which can include solid core conductors and/or stranded wire conductors. A wire includes (or is considered to be) a conductive path for carrying the AC electrical power.

In addition, some wiring devices such as, for example, electrical receptacles or outlets, and ground/arc fault circuit interrupters (GFCIs, AFCIs) include one or more electrical contacts disposed at least partially within a housing, the electrical contact being arranged and configured to accept a plug blade for supplying AC power to a connected load.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Disclosed herein is a wiring device. The wiring device including a housing and an electrical contact disposed at least partially within the housing, the electrical contact arranged and configured to accept a plug blade. When the plug blade is inserted into the electrical contact, the electrical contact is arranged and configured to apply a compressive force against the plug blade inserted therein. In some embodiments, the electrical contact includes first and second arms and first and second extending members, wherein the first and second extending members extend from the first and second arms, respectively, each of the first and second extending members are arranged and configured to contact a wall or a surface of the housing. When the plug blade is inserted into the electrical contact, each of the first and second extending members cooperate with the first and second arms, respectively to provide compressive force to the plug blade.

In some embodiments, the housing includes a pocket, one or more of the first and second extending members are arranged and configured to selectively contact a surface of the pocket.

In some embodiments, the first and second extending members are each arranged and configured to selectively contact a respective surface of the pocket.

In some embodiments, the electrical contact, the first and second arms, and the first and second extending members are monolithically formed.

An electrical contact is also disclosed. In some embodiments, the electrical contact includes a terminal portion, an axis along which a plug blade can be inserted, and first and second wipes positioned about the axis, each of the first and second wipes include first, second, and third segments. The first segments of the first and second wipes extend from the terminal portion, wherein each first segment projects from the terminal portion in a respective direction towards the axis. Each of the second segments extend from a respective first segment, the second segment projecting from the respective first segment in a respective direction away from the axis. Each of the third segments extend from a respective second segment, the third segment projecting from the respective second segment at a respective reflex angle with respect to the second segment, the third segment projecting from second segment in a direction away from the axis.

In some embodiments, the terminal portion is an arm configured to be engaged by a terminal block.

In some embodiments, the terminal portion is a tang configured to be engaged by a terminal block.

In some embodiments, the first and second wipes are positioned symmetrically about the axis.

In some embodiments, each of the second segments extends from the respective first segment at a blade contact region, the blade contact region configured to receive and engage a plug blade when the plug blade is inserted along the axis.

In some embodiments, the first segments are configured as primary springs, the second segments are configured as helper springs, and, when a plug blade is inserted along the axis, the primary springs each exert a respective force on the plug blade at the blade contact region, and the helper springs are each configured to increase the respective force exerted by the respective primary spring.

In some embodiments, each of the first and second wipes includes a convex surface in the blade contact region.

In some embodiments, when the electrical contact is positioned at least partially within a housing, one or more of the third segments is in contact with a surface of the housing.

In some embodiments, when the electrical contact is positioned at least partially within a housing, each of the third segments is in contact with one or more surfaces of the housing.

In some embodiments, the first segments are primary springs and the second segments are secondary springs.

In some embodiments, the terminal portion and the first, second, and third segments are monolithically formed.

A wiring device is disclosed. In some embodiments, the wiring device includes a housing and an electrical contact disposed at least partially within the housing, the electrical contact arranged and configured to accept a plug blade. In some embodiments, the electrical contact includes a terminal portion, an axis along which the plug blade can be inserted, and first and second wipes positioned about the axis, wherein each of the first and second wipes include first, second, and third segments. The first segments of the first and second wipes extend from the terminal portion, wherein each first segment projects from the terminal portion in a respective direction towards the axis. Each of the second segments extend from a respective first segment, the second segment projecting from the respective first segment in a respective direction away from the axis. Each of the third segments extend from a respective second segment, the third segment projecting from the respective second segment at a respective reflex angle with respect to the second segment, the third segment projecting from second segment in a direction away from the axis.

In some embodiments, the terminal portion is selected from one of an arm configured to be engaged by a terminal block and a tang configured to be engaged by a terminal block.

In some embodiments, the first and second wipes are positioned symmetrically about the axis.

In some embodiments, each of the second segments joins with the respective first segment at a blade contact region, the blade contact region configured to receive and engage a plug blade when the plug blade is inserted along the axis.

In some embodiments, the terminal portion and the first, second, and third segments are monolithically formed.

### BRIEF DESCRIPTION OF THE DRAWINGS

By way of example, a specific embodiment of the disclosed device will now be described, with reference to the accompanying drawings, in which:

FIG. 1A illustrates a perspective view of an embodiment of a wiring device (e.g., an electrical receptacle) in accordance with one or more features of the present disclosure, the wiring device including an improved electrical contact in accordance with one or more features of the present disclosure;

FIG. 1B illustrates a cross-sectional view of the wiring device of FIG. 1A;

FIG. 2 illustrates a perspective view of the electrical contact illustrated in FIG. 1B;

FIG. 3A illustrates a cross-sectional view of a plug blade from a plug being inserted into the electrical contact of the wiring device;

FIG. 3B illustrates a cross-sectional view of the plug blade inserted into the electrical contact of the wiring device;

FIG. 4A illustrates a cross-sectional view of an alternate embodiment of an electrical contact in accordance with one or more features of the present disclosure, the electrical contact illustrated within a wiring device; and

FIG. 4B illustrates an alternate cross-sectional view of the electrical contact shown in FIG. 4A, FIG. 4B illustrating a plug blade from a plug inserted into the electrical contact.

It should be understood that the drawings are not necessarily to scale and that the disclosed embodiments are sometimes illustrated diagrammatically and in partial views. In certain instances, details which are not necessary for an understanding of the disclosed methods and devices or which render other details difficult to perceive may have been omitted. It should be further understood that this disclosure is not limited to the particular embodiments illustrated herein. In the drawings, like numbers refer to like elements throughout unless otherwise noted.

### DETAILED DESCRIPTION

Various features of an improved electrical contact for use in a wiring device such as, for example, an electrical receptacle or outlet, ground/arc fault circuit interrupters (GFCIs, AFCIs), or the like, will now be described more fully hereinafter with reference to the accompanying drawings, in which one or more features of the electrical contact and/or wiring device will be shown and described. It should be appreciated that the various features may be used independently of, or in combination, with each other. It will be appreciated that the electrical contact as disclosed herein may be embodied in many different forms and should not be construed as being limited to the embodiment set forth herein. Rather, these embodiments are provided so that this disclosure will convey certain features of the electrical contact to those skilled in the art.

In accordance with one or more features of the present disclosure, an improved electrical contact for use in a wiring device is disclosed. The electrical contact being arranged and configured to provide improved blade retention and/or thermal performance. For example, in some embodiments, the electrical contact includes a double spring configuration so that, in use, the electrical contact is arranged and configured to apply a compressive force against the inserted plug blade.

Some types of wiring devices include electrical receptacles, ground/arc fault circuit interrupters (GFCIs, AFCIs), etc. In use, these types of wiring devices include one or more electrical contacts disposed at least partially within a housing thereof. The electrical contact being arranged and configured to accept a plug blade for supplying AC power, via a cord, to a connected load.

As will be appreciated by one of ordinary skill in the art, wiring devices may come in many forms, As used herein the term “wiring device” is intended to include any line voltage electrical device, which is currently known or hereafter developed. Line voltage refers to a voltage, typically Alternating Current (AC), that is supplied to buildings/residences (e.g., electric light and power), for example, 110 VAC, 115 VAC, 120 VAC, 125 VAC, 208 VAC, 220 VAC, 230 VAC, 240 VAC, single or multiphase. Line voltage devices are distinguished from low voltage devices, which refer to devices that receive a voltage which is less than a certain threshold (50 Volts for example, AC or DC). This reduced voltage is typically used for communication, signaling, data/multimedia transmission, low voltage charging, and the like.

As will be described herein, an improved electrical contact for use in certain forms of wiring devices will be disclosed. For example, an improved electrical contact for use in electrical receptacles and ground/arc fault circuit interrupters. In use, these types of wiring devices include one or more electrical contacts disposed at least partially within a housing thereof. The electrical contact being arranged and configured to accept a plug blade for supplying AC power, via a cord, to a connected load. However, the present disclosure should not be limited to any particular line voltage wiring device unless explicitly claimed.

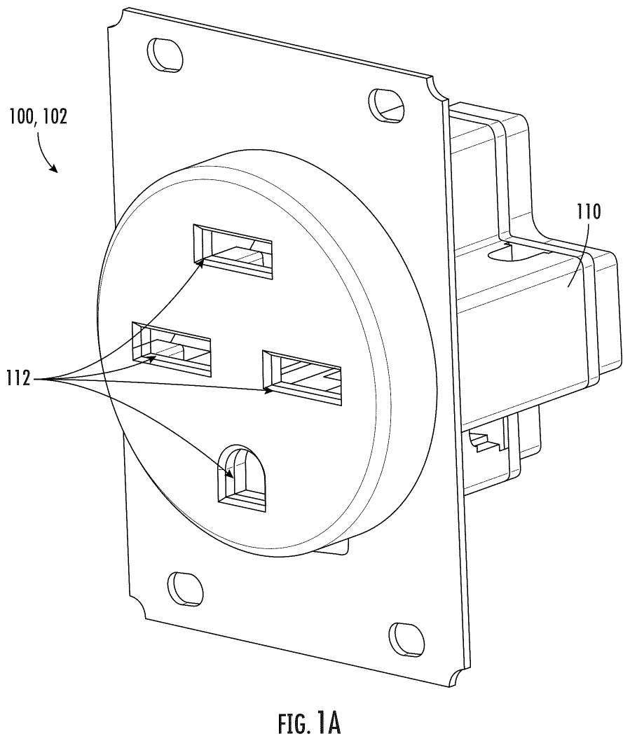

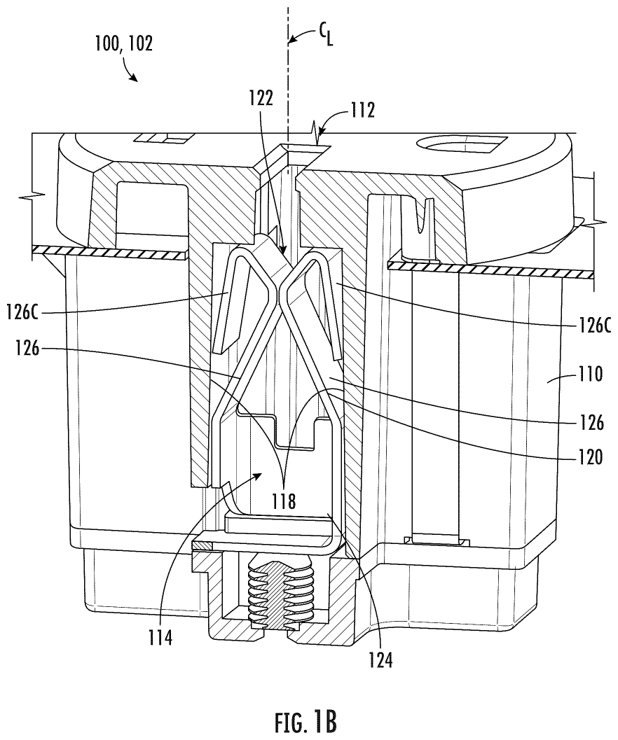

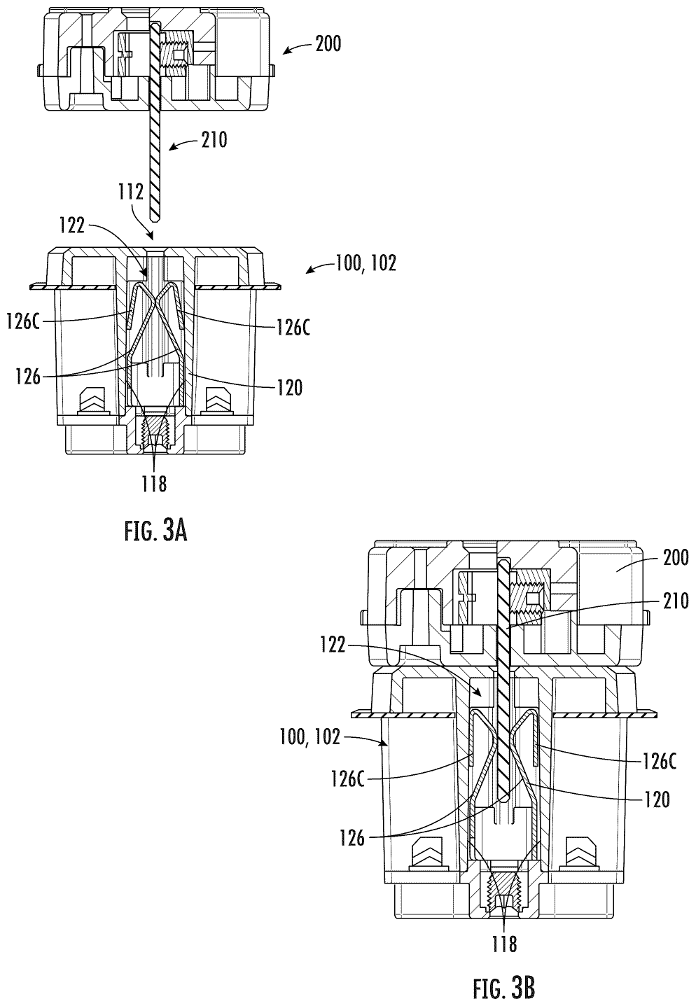

Referring to FIGS. 1A and 1B, in accordance with one or more features of the present disclosure, an example of an embodiment of a wiring device 100 is shown. As illustrated, the wiring device 100 is in the form of an electrical receptacle 102. The electrical receptacle 102 being arranged and configured to receive an electrical wire coupled to, and for supplying, line voltage. For example, in some embodiments, the electrical receptacle 102 may be arranged and configured to receive phase, neutral, and ground wires, although this is but one configuration and more or less wires may be coupled to the electrical receptacle 102. As illustrated, the electrical receptacle 102 includes a housing 110, which when assembled, enclose a variety of components. In use, the housing 110 includes one or more blade openings 112 and one or more pockets 114 arranged and configured to receive one or more electrical contacts 120. The housing 110 may include a plurality of blade openings 112 arranged and configured to enable a plug blade (e.g., 210 (FIGS. 3A and 3B)) from a plug (e.g., 200 (FIGS. 3A and 3B)) to be inserted therein. The plug 200 may in turn be coupled to a cord to supply power to a load. The number of blade openings 112, pockets 114, and electrical contacts 120 vary depending on the configuration and type of the electrical receptacle 102.

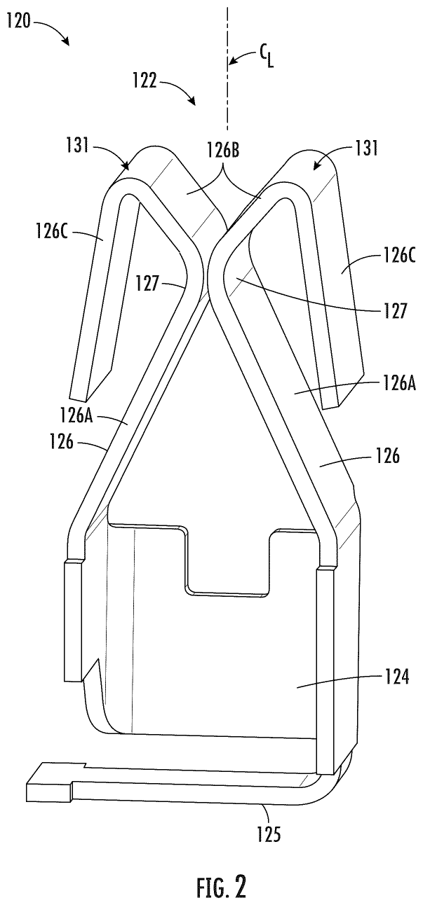

With additional reference to FIG. 2, each of the electrical contacts 120 includes, or defines, a blade insertion or contact region 122 arranged and configured to receive, engage, etc. a plug blade 210 from a plug 200 coupled thereto, or inserted into, the wiring device 100. That is, for example, as will be readily appreciated by one of ordinary skill in the art, with additional reference to FIGS. 3A and 3B, each electrical contact 120 includes a blade insertion or contact region 122 for receiving a plug blade 210 from a plug 200 which is inserted into the wiring device 100. Thus, as will be readily appreciated by one of ordinary skill in the art, the electrical contact 120 is arranged and configured to accept plug blades 210. The plug 200 may be coupled to a cord which supplies power to a load.

As illustrated, in some embodiments, each contact 120 may include a base or terminal portion 124 (terms used interchangeably herein without the intent to limit or distinguish) and first and second arms or wipes 126 extending therefrom (terms used interchangeably herein without the intent to limit or distinguish). The base 124 may be electrically coupled to conductors of the branch circuit wiring connected to an AC power source. For example, the base 124 may be configured as an arm or tang 125 configured to be engaged by a terminal block, although any suitable mechanism now known or hereafter developed for coupling the electrical contact to the branch circuit wiring may be used. The space between the first and second arms 126 defining the blade insertion or contact region 122 to receive the plug blade 210, although, as will be appreciated, the contacts 120 may have any suitable configuration or form now known or hereafter developed suitable for transferring incoming line-voltage from the branch circuit wiring to a load coupled to the wiring device 100. As such, the present disclosure should not be limited to any particular configuration or form of contact. As will be appreciated by one of ordinary skill in the art, the configuration or form of the contact may be dependent on the configuration and type of wiring device.

In use, the plug blade 210 of the plug 200 may be inserted into the blade insertion or contact region 122 along an axis CL. As illustrated, in some embodiments, each of the first and second arms 126 is positioned on either side of the axis CL. As illustrated, in some embodiments, the first and second wipes are positioned symmetrically about the axis CL.

In addition, each of the first and second arms 126 may include a first segment 126A, a second segment 126B, and a third segment 126C. As illustrated, the first segment 126A may extend from the base 124. In some embodiments, as illustrated, each of the first segments 126A may extend from the base 124 at an angle toward the axis CL. Each of the second segments 126B may extend from the first segment 126A at an angle projecting away from the axis CL. Each of the third segments 126C may extend from the second segment 126B. As illustrated, the third segment 126C may project from the second segment 126B at a respective reflex angle with respect to the second segment 126B. In some embodiments, the reflex angle being between 180 and 360 degrees. In use, the third segment 126C projects from the second segment 126B in a direction away from the axis CL.

In some embodiments, the second segment 126B may join or attach to the first segment 126A at a blade contact region 127 (e.g., transition between the first and second segments 126A, 126B defining a blade contact region 127), the blade contact region 127 being arranged and configured to receive and contact, engage, etc. the plug blade 210 when the plug blade 210 is inserted along the axis CL into the blade insertion or contact region 122. In some embodiments, as illustrated, each of the blade contact regions 127 of the first and second arms 126 includes or defines a convex surface.

Thus arranged, as illustrated, in some embodiments, the first and second arms 126 may be angled towards each other (e.g., the first and second arms 126 may be angled towards the axis CL) as they move away from the base 124 to the blade contact region 127. Thereafter, the first and second arms 126 may move away from each other (e.g., the first and second arms 126 may be angled away the axis CL).

In accordance with one or more features of the present disclosure, the contact 120 is arranged and configured to provide a compressive force so that, in use, when a plug blade 210 is inserted into the blade insertion or contact region 122, the first and second arms 126 are biased towards the inserted plug blade 210 (e.g., the first and second arms 126 are biased towards a closed position (i.e., toward each other)). For example, as illustrated, and as previously described, each of the first and second arms 126 may include a segment or extending member (e.g., the third segment 126C), which when inserted into the pockets 114 formed in the housing 110 are arranged and configured to interact with, contact, etc. walls or surfaces 118 of the housing 110. Thus arranged, in some embodiments, the interaction between the walls or surfaces 118 of the housing 110 and the third segment 126C of the arms 126 of the contact 120 provide a spring effect when the plug blade 210 of a plug 200 associated with a connected load is inserted into the electrical receptacle 102. That is, during use, as the first and second arms 126 open or move apart during insertion of the plug blade 210, the walls or surface 118 of the housing 110 contact the third segment 126C to provide additional force to the contact 120 to hold or secure the plug blades 210. Alternatively, during use, the walls or surfaces 118 of the housing 110 may be in continuous contact with the third segment 126C to provide additional force to the contact 120 to hold or secure the plug blades 210 when the plug 200 is inserted. In either event, this spring effect prevents the contact 120 from yielding and helps maintain high retention forces against the plug blade 210. In addition, due to the additional force exerted, and/or the surface area of the contact, between the contact 120 with the plug blade 210, improved heat dissipation and improved thermal performance is achieved. As such, while the features of the present disclosure may be used in connection with any form or type of electrical receptacle, the improved heat dissipation and thermal performance are even more useful in connection with high current wiring devices such as receptacles.

Thus arranged, in use, when the electrical contact 120 is positioned at least partially within the housing 110, one or more of the third segments 126C may contact, engage, etc. a surface or wall 118 of the housing 110. Alternatively, and/or in addition, when the electrical contact 120 is positioned at least partially within the housing 110, each of the third segments 126C may contact, engage, etc. one or more surfaces or walls 118 of the housing 110.

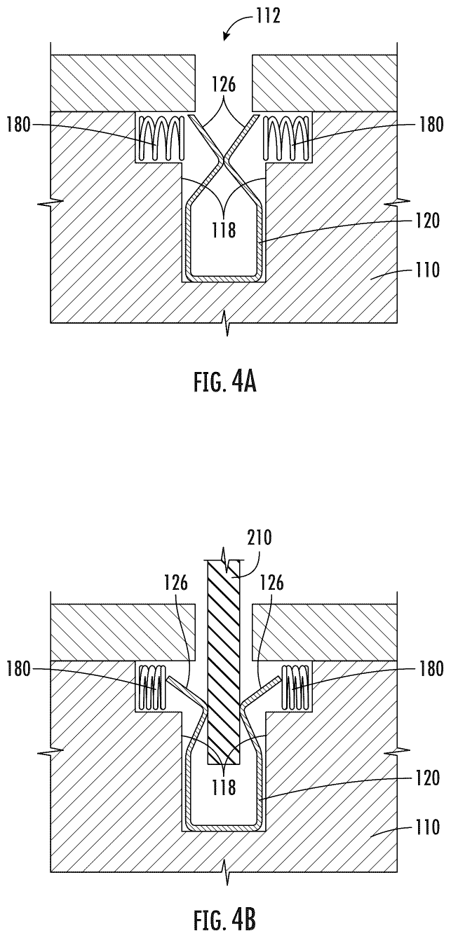

In some embodiments, as illustrated, the electrical contact 120 including the first, second, and third segments may be integrally or monolithically formed. Thus arranged, for example, the third segment 126C may form a living hinge 131 with the second segments 126B of the first and second arms 126 at an end of the second segments 126B opposite the base 124, although this is but one configuration and any other suitable form may be used in accordance with the principles of the present disclosure. For example, the third segment or extending members may extend from the first and second arms at alternate locations. Alternatively, for example, the third segment or extending members may be separately formed and coupled to the electrical contact. Alternatively, with reference to FIGS. 4A and 4B, it is envisioned that the third segment or extending members may be omitted entirely and alternate mechanisms may be used to bias the first and second arms 126 of the contacts 120 during use, such as, for example, via one or more springs 180 positioned between the arms 126 of the contact 120 and the walls or surfaces 118 of the housing 110.

In some embodiments, the first segments 126A may be configured as primary springs and the second segments 126B may be configured as secondary springs. Thus arranged, the first segments 126A may be primary springs and the second segments 126B may be helper springs so that when a plug blade 210 is inserted along the axis CL, the primary springs exert a respective force on the plug blade 210 at the blade contact region 127 and the helper springs are configured to increase the respective force exerted by the respective primary spring.

As will be readily appreciated by one of ordinary skill in the art, the electrical contact may be manufactured from any suitable conductive material now known or hereafter developed. In addition, while the illustrated electrical receptacle is shown having four openings, and thus four electrical contacts positioned therein, this is but one configuration and the electrical receptacle may have more of less openings and contacts depending on the type and configuration of the electrical receptacle. For example, a standard duplex residential receptacle may include three openings and three contacts for each outlet in the receptacle. As such, the present disclosure should not be limited to any particular wiring device unless explicitly claimed.

The foregoing description has broad application. While the present disclosure refers to certain embodiments, numerous modifications, alterations, and changes to the described embodiments are possible without departing from the sphere and scope of the present disclosure, as defined in the appended claim(s). Accordingly, it is intended that the present disclosure not be limited to the described embodiments. Rather these embodiments should be considered as illustrative and not restrictive in character. All changes and modifications that come within the spirit of the invention are to be considered within the scope of the disclosure. The present disclosure should be given the full scope defined by the language of the following claims, and equivalents thereof. The discussion of any embodiment is meant only to be explanatory and is not intended to suggest that the scope of the disclosure, including the claims, is limited to these embodiments. In other words, while illustrative embodiments of the disclosure have been described in detail herein, it is to be understood that the inventive concepts may be otherwise variously embodied and employed, and that the appended claims are intended to be construed to include such variations, except as limited by the prior art. Unless otherwise defined, all technical terms used herein have the same meaning as commonly understood by one of ordinary skill in the art to which the disclosure belongs.

Directional terms such as top, bottom, superior, inferior, medial, lateral, anterior, posterior, proximal, distal, upper, lower, upward, downward, left, right, longitudinal, front, back, above, below, vertical, horizontal, radial, axial, clockwise, and counterclockwise) and the like may have been used herein. Such directional references are only used for identification purposes to aid the reader's understanding of the present disclosure. For example, the term “distal” may refer to the end farthest away from the medical professional/operator when introducing a device into a patient, while the term “proximal” may refer to the end closest to the medical professional when introducing a device into a patient. Such directional references do not necessarily create limitations, particularly as to the position, orientation, or use of this disclosure. As such, directional references should not be limited to specific coordinate orientations, distances, or sizes, but are used to describe relative positions referencing particular embodiments. Such terms are not generally limiting to the scope of the claims made herein. Any embodiment or feature of any section, portion, or any other component shown or particularly described in relation to various embodiments of similar sections, portions, or components herein may be interchangeably applied to any other similar embodiment or feature shown or described herein.

It should be understood that, as described herein, an “embodiment” (such as illustrated in the accompanying Figures) may refer to an illustrative representation of an environment or article or component in which a disclosed concept or feature may be provided or embodied, or to the representation of a manner in which just the concept or feature may be provided or embodied. However, such illustrated embodiments are to be understood as examples (unless otherwise stated), and other manners of embodying the described concepts or features, such as may be understood by one of ordinary skill in the art upon learning the concepts or features from the present disclosure, are within the scope of the disclosure. Furthermore, references to “one embodiment” of the present disclosure are not intended to be interpreted as excluding the existence of additional embodiments that also incorporate the recited features.

In addition, it will be appreciated that while the Figures may show one or more embodiments of concepts or features together in a single embodiment of an environment, article, or component incorporating such concepts or features, such concepts or features are to be understood (unless otherwise specified) as independent of and separate from one another and are shown together for the sake of convenience and without intent to limit to being present or used together. For instance, features illustrated or described as part of one embodiment can be used separately, or with another embodiment to yield a still further embodiment. Thus, it is intended that the present subject matter covers such modifications and variations as come within the scope of the appended claims and their equivalents.

As used herein, an element or step recited in the singular and proceeded with the word “a” or “an” should be understood as not excluding plural elements or steps, unless such exclusion is explicitly recited. It will be further understood that the terms “comprises” and/or “comprising,” or “includes” and/or “including” when used herein, specify the presence of stated features, regions, steps, elements and/or components, but do not preclude the presence or addition of one or more other features, regions, integers, steps, operations, elements, components and/or groups thereof.

The phrases “at least one,” “one or more,” and “and/or,” as used herein, are open-ended expressions that are both conjunctive and disjunctive in operation. The terms “a” (or “an”), “one or more” and “at least one” can be used interchangeably herein.

Connection references (e.g., engaged, attached, coupled, connected, and joined) are to be construed broadly and may include intermediate members between a collection of elements and relative to movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority but are used to distinguish one feature from another. The drawings are for purposes of illustration only and the dimensions, positions, order and relative to sizes reflected in the drawings attached hereto may vary.

The foregoing discussion has been presented for purposes of illustration and description and is not intended to limit the disclosure to the form or forms disclosed herein. For example, various features of the disclosure are grouped together in one or more embodiments or configurations for the purpose of streamlining the disclosure. However, it should be understood that various features of the certain embodiments or configurations of the disclosure may be combined in alternate embodiments or configurations. Moreover, the following claims are hereby incorporated into this Detailed Description by this reference, with each claim standing on its own as a separate embodiment of the present disclosure.

What is claimed is:

1. A wiring device, comprising:
a housing; and
an electrical contact disposed at least partially within the housing, the electrical contact arranged and configured to accept a plug blade;
wherein, when the plug blade is inserted into the electrical contact, the electrical contact is arranged and configured to apply a compressive force against the plug blade inserted therein;
wherein the electrical contact includes first and second arms and first and second extending members;
wherein the first and second extending members extend from the first and second arms, respectively, each of the first and second extending members are arranged and configured to contact a wall or a surface of the housing; and
wherein, when the plug blade is inserted into the electrical contact, each of the first and second extending members cooperate with the first and second arms, respectively to provide compressive force to the plug blade.

2. The wiring device of claim 1, wherein the housing includes a pocket, one or more of the first and second extending members are arranged and configured to selectively contact a surface of the pocket.

3. The wiring device of claim 2, wherein the first and second extending members are each arranged and configured to selectively contact a respective surface of the pocket.

4. The wiring device of claim 2, wherein the electrical contact, the first and second arms, and the first and second extending members are monolithically formed.

5. An electrical contact comprising:
a terminal portion;
an axis along which a plug blade can be inserted; and
first and second wipes positioned about the axis, each of the first and second wipes include first, second, and third segments;
wherein the first segments of the first and second wipes extend from the terminal portion, wherein each first segment projects from the terminal portion in a respective direction towards the axis;
wherein each of the second segments extend from a respective first segment, the second segment projecting from the respective first segment in a respective direction away from the axis;
wherein each of the third segments extend from a respective second segment, the third segment projecting from the respective second segment at a respective reflex angle with respect to the second segment, the third segment projecting from second segment in a direction away from the axis.

6. The electrical contact of claim 5, wherein the terminal portion is an arm configured to be engaged by a terminal block.

7. The electrical contact of claim 5, wherein the terminal portion is a tang configured to be engaged by a terminal block.

8. The electrical contact of claim 5, wherein the first and second wipes are positioned symmetrically about the axis.

9. The electrical contact of claim 5, wherein each of the second segments extends from the respective first segment at a blade contact region, the blade contact region configured to receive and engage a plug blade when the plug blade is inserted along the axis.

10. The electrical contact of claim 9, wherein:
the first segments are configured as primary springs;
the second segments are configured as helper springs; and
wherein when a plug blade is inserted along the axis:
the primary springs each exert a respective force on the plug blade at the blade contact region; and
the helper springs are each configured to increase the respective force exerted by the respective primary spring.

11. The electrical contact of claim 9, wherein each of the first and second wipes includes a convex surface in the blade contact region.

12. The electrical contact of claim 5, wherein when the electrical contact is positioned at least partially within a housing, one or more of the third segments is in contact with a surface of the housing.

13. The electrical contact of claim 5, wherein when the electrical contact is positioned at least partially within a housing, each of the third segments is in contact with one or more surfaces of the housing.

14. The electrical contact of claim 5, wherein the first segments are primary springs and the second segments are secondary springs.

15. The electrical contact of claim 5, wherein the terminal portion and the first, second, and third segments are monolithically formed.

16. A wiring device, comprising:
a housing; and
an electrical contact disposed at least partially within the housing, the electrical contact arranged and configured to accept a plug blade, the electrical contact including:
a terminal portion;
an axis along which the plug blade can be inserted;
first and second wipes positioned about the axis, wherein each of the first and second wipes include first, second, and third segments;
wherein the first segments of the first and second wipes extend from the terminal portion, wherein each first segment projects from the terminal portion in a respective direction towards the axis;
wherein each of the second segments extend from a respective first segment, the second segment projecting from the respective first segment in a respective direction away from the axis;
wherein each of the third segments extend from a respective second segment, the third segment projecting from the respective second segment at a respective reflex angle with respect to the second segment, the third segment projecting from second segment in a direction away from the axis.

17. The wiring device of claim 16, wherein the terminal portion is selected from one of an arm configured to be engaged by a terminal block and a tang configured to be engaged by a terminal block.

18. The wiring device of claim 16, wherein the first and second wipes are positioned symmetrically about the axis.

19. The wiring device of claim 16, wherein each of the second segments joins with the respective first segment at a blade contact region, the blade contact region configured to receive and engage a plug blade when the plug blade is inserted along the axis.

20. The wiring device of claim 16, wherein the terminal portion and the first, second, and third segments are monolithically formed.
